(19) United States
(12) Patent Application Publication
(10) Pub. No.: US 2025/0153929 A1
(43) Pub. Date: May 15, 2025

(54) DISPENSING, COLLECTION, AND STORAGE SYSTEM FOR PET WASTE, CONTAINMENT SYSTEM, PROCESS, AND METHODS OF USE

(71) Applicant: Mary Lambright, North Crystal, MN (US)

(72) Inventor: Mary Lambright, North Crystal, MN (US)

(21) Appl. No.: 18/942,493

(22) Filed: Nov. 9, 2024

Related U.S. Application Data
(60) Provisional application No. 63/548,217, filed on Nov. 12, 2023.

(51) Int. Cl. B65F 1/14; A47K 10/36

(52) U.S. Cl. CPC B65F 1/1426; A47K 10/36; B65F 2240/136

(57) ABSTRACT

A dispensing, collection, and storage system for pet waste, a containment system, process, and method of use are presented. The system provides for dispensing of waste collection bags in a convenient and easy to grab manner; a manner which can be grabbed easily with a single hand. Furthermore, the disclosure provides a system which carries a dog's waste so that a user doesn't have to hold in hand and/or hold a waste bag and/or attach a waste bag to a leash. In this way, the current system provides a unique way of collecting and disposing of pet waste.

### CROSS-REFERENCE TO RELATED APPLICATIONS

The present application claims priority to the U.S. Provisional Patent Application No. 63/548,217 which was filed on Nov. 12, 2023, which is hereby incorporated by reference herein in its entirety, including any figures, tables, or drawings.

### FIELD OF THE INVENTION

This disclosure relates to a dispensing, collection, and storage system for pet waste, a containment system, process, and method of use. The present disclosure provides for dispensing of waste collection bags in a convenient and easy to grab manner; a manner which can be grabbed easily with a single hand.

### BACKGROUND OF THE INVENTION

In recent times, the number of urban and suburban households with pets has increased dramatically. In particular, dog ownership and/or dogs as companions has grown in popularity. Said another way, many households now include at least one dog as part of the grouping and/or family.

Local governments have enacted ordinances requiring pet owners to clean up after their pets in order to reduce pedestrian hazards and increase sanitation conditions in the public streets and outdoor facilities. The waste or debris left by domestic animals is unsightly, and more importantly often presents a health hazard. This is desirable because pets are often on walks or outside of the home in public spaces where pets can leave waste.

Currently, in the state of the art, various devices have been designed to assist pet owners in cleaning up their pets' feces. However, such tools are for the most part unsanitary and only marginally effective. These tools include a variety of scoops for shoveling, bags for catching and tongs for grasping pet wastes. They tend to be bulky and require daily washing after use. For example, some tools require both hands from the pet owner, in multiple steps, to maneuver, complicating the whole routine of collection and disposal. Other tools risk exposing the owner's hand to the pet waste, presenting another sanitary hazard for the pet owner. As such, the conventional devices have not been widely embraced by the pet-owning public.

Complicating matters further, the existing state of the art does not provide an owner with a dignified way of picking up pet waste. Said another way, an owner, user or pet owner is often engaging socially while trying to simultaneously pick up a pet's waste. This is undesirable in a social setting where complicated pet waste collection is undignified at best, and worst can be embarrassing in the current state of the art.

Thus, there is a long-felt need in the art for a dispensing, collection, and storage system for pet waste, a containment system, process, and method of use which improves upon the state of the art and solves the problems mentioned herein such as improving dignity of a user and improving upon situations of taking a pet in public.

The disclosure herein provides these advantages and others as will become clear from the specification and claims provided.

### SUMMARY OF THE INVENTION

A dispensing, collection, and storage system for pet waste, a containment system, process, and method of use are presented.

Thus, it is a primary object of the disclosure to provide a dispensing, collection, and storage system for pet waste, a containment system, process, and method of use that improves upon the state of the art.

Another object of the disclosure is to provide a dispensing, collection, and storage system for pet waste, a containment system, process, and method of use that provides for dispensing of waste collection bags in a convenient and easy to grab manner; a manner which can be grabbed easily with a single hand.

Yet another object of the disclosure is to provide a dispensing, collection, and storage system for pet waste, a containment system, process, and method of use that carries a dogs waste so that a user doesn't have to hold in hand and/or hold a waste bag and/or attach a waste bag to a leash.

Another object of the disclosure is to provide a dispensing, collection, and storage system for pet waste, a containment system, process, and method of use that does not get dirty or require carrying a receptacle which is stained or contaminated.

Yet another object of the disclosure is to provide a dispensing, collection, and storage system for pet waste, a containment system, process, and method of use that is easy and convenient to use.

Another object of the disclosure is to provide a dispensing, collection, and storage system for pet waste, a containment system, process, and method of use that is easy to remove and clean.

Yet another object of the disclosure is to provide a dispensing, collection, and storage system for pet waste, a containment system, process, and method of use that works in concert with almost all dog harnesses.

Another object of the disclosure is to provide a dispensing, collection, and storage system for pet waste, a containment system, process, and method of use that is secure.

Yet another object of the disclosure is to provide a dispensing, collection, and storage system for pet waste, a containment system, process, and method of use that does not irritate or inconvenience a pet and/or dog when engaged with the dog's harness.

Another object of the disclosure is to provide a dispensing, collection, and storage system for pet waste, a containment system, process, and method of use that fits a variety of sizes.

Yet another object of the disclosure is to provide a dispensing, collection, and storage system for pet waste, a containment system, process, and method of use that is available in a variety of sizes.

Another object of the disclosure is to provide a dispensing, collection, and storage system for pet waste, a containment system, process, and method of use that disguises the scent of waste.

Yet another object of the disclosure is to provide a dispensing, collection, and storage system for pet waste, a containment system, process, and method of use that provides for easy storage and dispensing of waste bags.

Another object of the disclosure is to provide a dispensing, collection, and storage system for pet waste, a containment system, process, and method of use that is relatively affordable.

Yet another object of the disclosure is to provide a dispensing, collection, and storage system for pet waste, a containment system, process, and method of use that prevents hand cramping for a user.

Another object of the disclosure is to provide a dispensing, collection, and storage system for pet waste, a containment system, process, and method of use that provides for pets being able to carry their own waste.

Yet another object of the disclosure is to provide a dispensing, collection, and storage system for pet waste, a containment system, process, and method of use that provides a solution to owners carrying waste.

Another object of the disclosure is to provide a dispensing, collection, and storage system for pet waste, a containment system, process, and method of use that works with plastic bags.

Yet another object of the disclosure is to provide a dispensing, collection, and storage system for pet waste, a containment system, process, and method of use that works with various desired bag or collection device materials; such as but not limited to recyclable materials and the like.

Another object of the disclosure is to provide a dispensing, collection, and storage system for pet waste, a containment system, process, and method of use that is easy to use.

Yet another object of the disclosure is to provide a dispensing, collection, and storage system for pet waste, a containment system, process, and method of use that is safe to use.

Another object of the disclosure is to provide a dispensing, collection, and storage system for pet waste, a containment system, process, and method of use which is aesthetically pleasing in design.

Yet another object of the disclosure is to provide a dispensing, collection, and storage system for pet waste, a containment system, process, and method of use that is secured to a harness by an easy to secure strap, such as utilization of hook and loop, straps, buttons, and the like.

Another object of the disclosure is to provide a dispensing, collection, and storage system for pet waste, a containment system, process, and method of use that comes in a variety of securement feature types for various harnesses and desires.

Yet another object of the disclosure is to provide a dispensing, collection, and storage system for pet waste, a containment system, process, and method of use that is easily removable and machine washable.

Another object of the disclosure is to provide a dispensing, collection, and storage system for pet waste, a containment system, process, and method of use that does not dislodge or create messes.

Yet another object of the disclosure is to provide a dispensing, collection, and storage system for pet waste, a containment system, process, and method of use that is quick and efficient.

Yet another object of the disclosure is to provide a dispensing, collection, and storage system for pet waste, a containment system, process, and method of use that is robust.

Another object of the disclosure is to provide a dispensing, collection, and storage system for pet waste, a containment system, process, and method of use that saves time for a user.

Yet another object of the disclosure is to provide a dispensing, collection, and storage system for pet waste, a containment system, process, and method of use that saves energy.

Another object of the disclosure is to provide a dispensing, collection, and storage system for pet waste, a containment system, process, and method of use that are high quality.

These and other objects, features, or advantages of the present disclosure will become apparent from the specification and claims.

### BRIEF DESCRIPTION OF DRAWINGS

The drawings accompanying and forming part of this specification are included to depict certain aspects of the disclosure.

FIG. 1 is a top, perspective view of the dispensing, collection, and storage system for pet waste; the view showing a main body having an upper portion and a lower portion; the view showing a strap; the view showing a dispenser; the view showing the system in a closed position.

FIG. 2 is a bottom, perspective view of the dispensing, collection, and storage system for pet waste; the view showing a main body having an upper portion and a lower portion; the view showing a strap.

FIG. 3 is a side view of the dispensing, collection, and storage system for pet waste; the view showing a main body having an upper portion and a lower portion; the view showing a strap.

FIG. 4 is a side view of the dispensing, collection, and storage system for pet waste; the view showing a main body having an upper portion and a lower portion; the view showing a strap.

FIG. 5 is a top view of the dispensing, collection, and storage system for pet waste; the view showing a main body having an upper portion and a lower portion; the view showing a strap; the view showing a dispenser.

FIG. 6 is a bottom view of the dispensing, collection, and storage system for pet waste; the view showing a main body having an upper portion and a lower portion; the view showing a strap.

FIG. 7 is a front view of the dispensing, collection, and storage system for pet waste; the view showing a main body having an upper portion and a lower portion; the view showing a strap; the view showing a dispenser.

FIG. 8 is a rear view of the dispensing, collection, and storage system for pet waste; the view showing a main body having an upper portion and a lower portion; the view showing a strap; the view showing a dispenser.

FIG. 9 is a perspective view of the dispensing, collection, and storage system for pet waste; the view showing a main body having an upper portion and a lower portion; the view showing a strap; the view showing the system in an open position.

FIG. 10 is a perspective view of the dispensing, collection, and storage system for pet waste; the view showing a main body having an upper portion and a lower portion; the view showing a strap with an adjustment and securement feature.

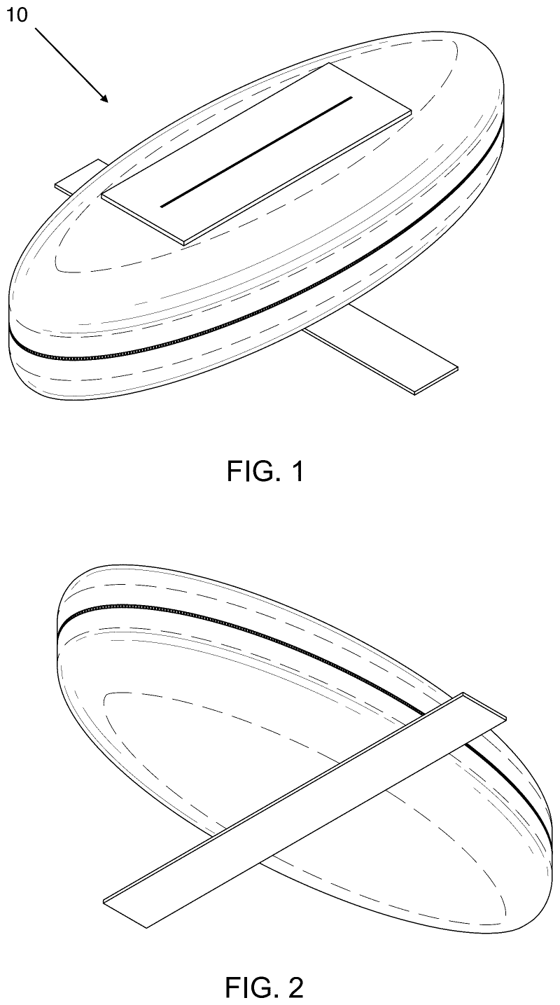

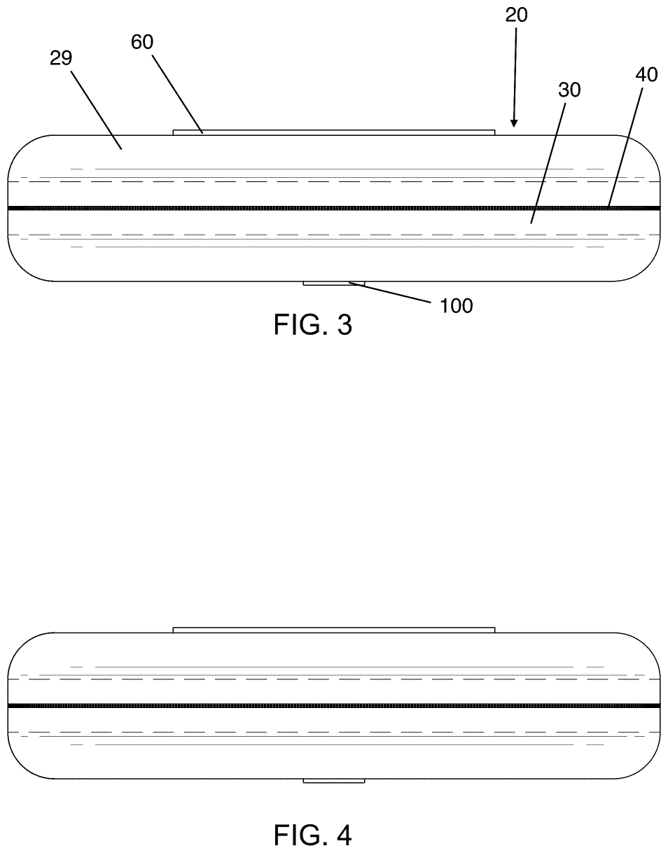

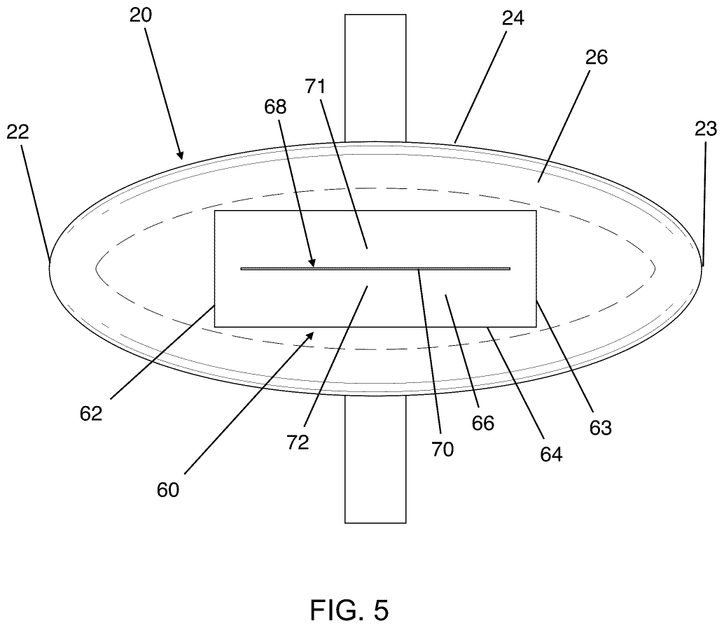

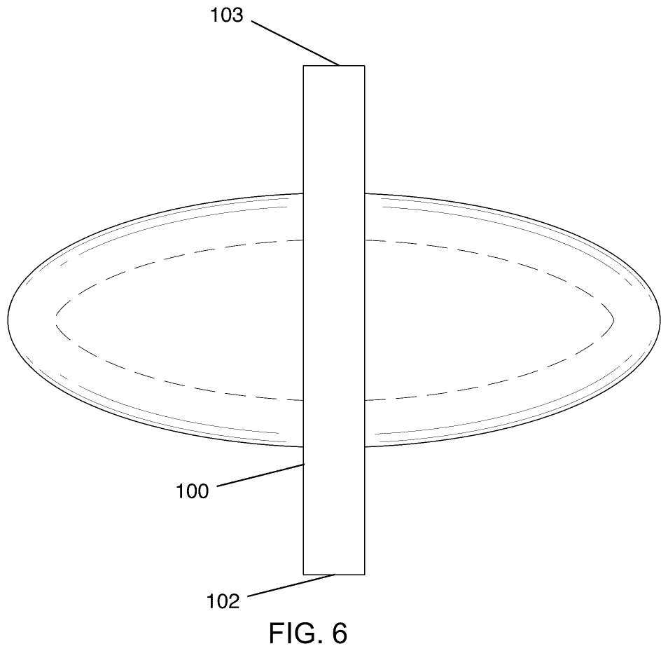

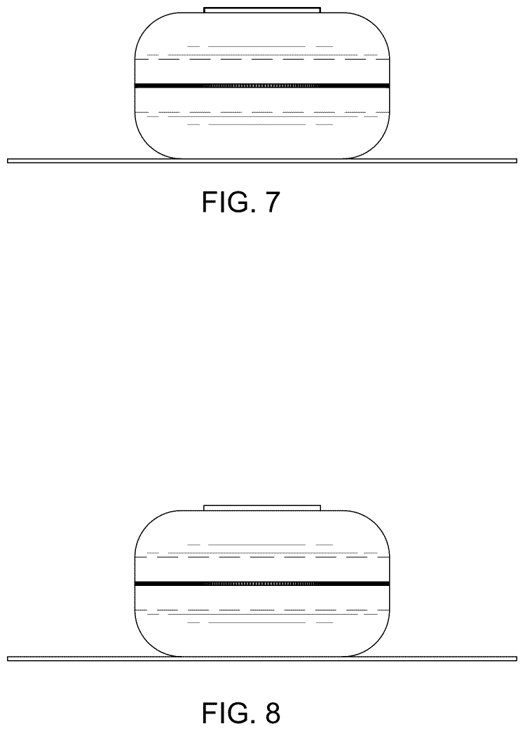

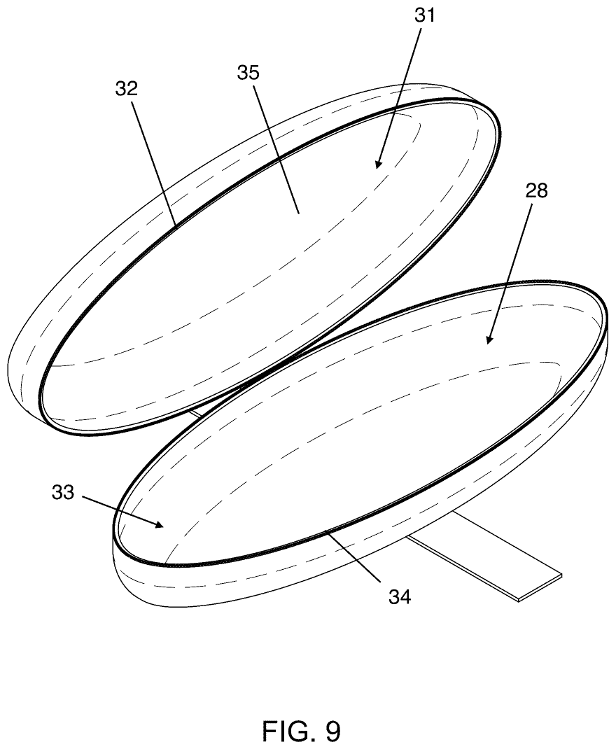

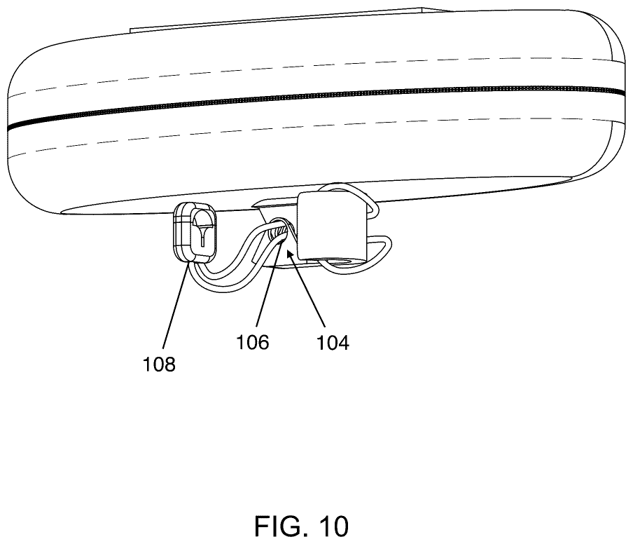

### DESCRIPTION

In the following detailed description, reference is made to the accompanying drawings which form a part hereof, and in which is shown by way of illustration specific embodiments in which the disclosure may be practiced. These embodiments are described in sufficient detail to enable those skilled in the art to practice the disclosure, and it is to be understood that other embodiments may be utilized and that mechanical, procedural, and other changes may be made without departing from the spirit and scope of the disclosure(s). The following detailed description is, therefore, not to be taken in a limiting sense, and the scope of the disclosure(s) is defined only by the appended claims, along with the full scope of equivalents to which such claims are entitled.

As used herein, the terminology such as vertical, horizontal, top, bottom, front, back, end, sides and the like are referenced according to the views, pieces and figures presented. It should be understood, however, that the terms are used only for purposes of description, and are not intended to be used as limitations. Accordingly, orientation of an object or a combination of objects may change without departing from the scope of the disclosure.

Reference throughout this specification to “one embodiment,” “an embodiment,” “one example,” or “an example” means that a particular feature, structure, or characteristic described in connection with the embodiment or example is included in at least one embodiment of the present disclosure. Thus, the appearance of the phrases “in one embodiment,” “in an embodiment,” “one example,” or “an example” in various places throughout this specification are not necessarily all referring to the same embodiment or example. Furthermore, the particular features, structures, databases, or characteristics may be combined in any suitable combinations and/or sub-combinations in one or more embodiments or examples. In addition, it should be appreciated that the figures provided herewith are for explanation purposes to persons ordinarily skilled in the art and that the drawings are not necessarily drawn to scale.

### System:

With reference to the figures, a dispensing, collection, and storage system for pet waste, a containment system, process, and method of use 10 are presented, a dispensing, collection, and storage system for pet waste, a containment system, process, and method of use 10 (hereafter referred to as “collection system”, “storage system”, “containment system”, “pet waste collection”, “dispensing system”, “waste collection system”, or simply “system”) is formed of any suitable size, shape and design.

In the arrangement shown, as one example, system 10 is configured to carry a dog's waste and/or a pet's waste on the dog rather than force the owner and/or user to carry the waste. Said another way, system 10 is configured to provide a means for a waste bag used to collect contaminants to be easily carried by the dog securely without creating any mess or risk of a mess. In this way, a user does not have to carry by hand, hold in hand during social situations and/or interactions and the like. Furthermore, a user does not have to attach a waste bag to a leash and/or directly to a dog's harness.

Furthermore, and in the arrangement shown, as one example, system 10 is configured to aid in walking a dog in this way. System 10 is configured to provide a receptacle for accepting dog waste and/or a doggie bag with waste. This is a more sanitary and cleanliness solution which also prevents smelling undesired odors during a walk, being at a dog park, on an elevator, in public, and the like.

### Main Body:

In the arrangement shown, as one example, the main structure of system 10 includes a main body 20 extending a length from a first end 22 to a second end 23 between opposing sides 24 having an exterior surface 26 and an interior surface 28. In the arrangement shown, as one example, the main body 20 is formed of an upper portion 29 and a lower portion 30. In the arrangement shown, as one example, the upper portion 29 includes a top interior 31 and a top seam 32. Furthermore, the lower portion 30 includes a lower interior 33 and a bottom seam 34.

In the arrangement shown, as one example, the main body 20 is generally oval in shape when viewed from the top. The main body 20 is elongated from the first end to the second end. In the arrangement shown, as one example, the main body 20 has generally curved or softened edges.

Liner: In the arrangement shown, as one example, main body 20 may also include a liner 35. Liner 35 is formed of any suitable size, shape, and design and is configured to provide a smooth easy to clear surface along the interior of the main body 20. In this way, waste can be discarded directly into the main body via a napkin, or the like. The liner 35 can then be easily wiped clean in between uses and the like.

### Closure Feature:

In the arrangement shown, as one example, system 10 also includes a closure feature 40 or zipper 40. Zipper 40 extends a length from a first end to a second end around the perimeter of the main body.

While a zipper extending a length from a first end to a second end around the perimeter of the main body is hereby contemplated for use, other closure devices are also considered. In another example, magnetic enclosures or magnetic clasps are contemplated to secure the upper portion to the lower portion. Similarly, clips, clasps, buckles, and the like are contemplated for use.

### Dispenser:

In the arrangement shown, as one example, system 10 includes a dispenser 60. Dispenser is formed of any suitable size, shape, and design and is configured to dispense doggy bags, bags, napkins, paper towels, wet wipes, and the like. Dispenser 60 extends a length from a first end 62 to a second end 63 between opposing sides 64. In the arrangement shown, as one example, dispenser 60 is generally rectangular in shape and secured via stitching, or the like, to the top of the main body 20.

Furthermore, in the arrangement shown, dispenser 60 includes an exterior surface 66 and/or may be integrated into the main body of the system 10. Said another way, dispenser 60 may be configured and/or attached to the surface of the top of the main body. Alternatively, dispenser 60 may be incorporated into the main body such that the baggies and the like are stored within the interior of the main body 20 while a small opening in the top of the upper portion of the main body 20 serves as the dispenser to the exterior of the main body 20.

In the arrangement shown, as one example, the dispenser 60 further includes a first lip 71 and a second lip 72. The first lip 71 and the second lip 72 are configured to be in close and tight tolerances, meaning that they are touching when not in use. Enough space to allow for a doggy bag or napkin to slide between them is provided. The tolerances will tear a tapered baggy section and/or tear the section between two baggies, napkins, or the like.

The dispenser includes a hollow interior 68 for waste bag storage and/or storage of other items and the like. In the arrangement shown, as one example, the dispenser also includes an opening 70 and/or dispenser for dispensing of baggies and the like. The dispenser may also be separate and include its own attachment features, among other components, features, and functionality.

In the arrangement shown, as one example, the opening of the dispenser 60 is configured as a small slit or slender opening. This opening is configured such that the grip is tight and/or the rubber of the dispenser 70 situated in close and tight tolerances of the doggy bag. In this way, the opening provides enough frictional force to grip the bag such that a single bag can be exposed and/or dispensed at one time. Furthermore, in this way, the force can provide for gripping tightly so that tearing of the doggy bags occurs to detach a first bag from a second bag and so forth.

### Strap:

In the arrangement shown, as one example, system 10 includes a plurality of straps 100 or strap 100. Strap 100 is formed of any suitable size, shape, and design and is configured to attach the main body 20 of the system to a harness, leash, collar, or the like. Strap 100 is configured to be easily removable such that the entire system 10 can be quickly secured or removed from a harness, leash, cart, or the like.

In the arrangement shown, as one example, the strap and/or plurality of straps are configured to secure system 10 to the harness of a dog. In the arrangement shown as one example, a hook and loop strap is included to easily secure the system 10. However, strap may be made of a variety of securement and/or attachment features. Also contemplated for use are buttons, friction fit, buckles, straps, clips, an integrated pocket, and other securement features, a combination thereof, and the like, among other components, features, and functionality.

In the arrangement shown, as one example, strap 100 extends a length from a first end 102 to a second end 103. Strap 100 may also include a tightener 104, in an alternative embodiment; the tightener including a first aperture 106 and second aperture 108 for securing the system and/or tightening. Furthermore, the tightener may also include a hook for storing excess elastic band.

In the arrangement shown, as one example, strap 100 is formed of a bungee cord or an elastic cord such that the strap has some extendable stretching to the strap.

### User (or Plurality Thereof):

In the arrangement shown, as one example, system 10 includes a user. User may be any user interacting with or utilizing the system 10. This may include viewing, controlling, analyzing, manipulating, and/or interacting with system 10. User is not limited to a single user but may be a plurality of users.

In addition to the above identified features, options, controls, and components, system 10 may also include other features and functionalities, among other options, controls, and components.

It will be appreciated by those skilled in the art that other various modifications could be made to the system, process, and method of use without parting from the spirit and scope of this disclosure. All such modifications and changes fall within the scope of the claims and are intended to be covered thereby.

1. A dispensing, collection, and storage system, comprising:
a main body;
the main body extending a length from a first end to a second end between opposing sides;
the main body having an exterior surface and a hollow interior;
the main body having an upper portion;
the upper portion of the main body having a top interior;
the upper portion of the main body having a top seam;
the main body having a lower portion;
the lower portion of the main body having a bottom interior;
the lower portion of the main body having a bottom seam;
a closure feature;
a dispenser;
the dispenser extending a length from a first end to a second end between opposing sides;
the dispenser having an exterior surface and a hollow interior;
the dispenser having an opening;
a strap;
the strap extending a length from a first end to a second end between opposing sides.

2. The system of claim 1, further comprising:
the main body having a liner;
wherein the liner is formed of a smooth, thin polymer.

3. The system of claim 1, further comprising:
wherein the closure feature is a zipper.

4. The system of claim 1, further comprising:
wherein the closure feature is formed of a plurality of magnets.

5. The system of claim 1, further comprising:
wherein the opening of the dispenser is configured in close and tight tolerances so as to provide for touching of the first lip and the second lip when not in use.

6. The system of claim 1, further comprising:
wherein the dispenser is configured to store a plurality of napkins;
wherein the dispenser can be reloaded with the plurality of napkins from the interior of the main body.

7. The system of claim 1, further comprising:
wherein the dispenser is configured to store a plurality of waste bags;
wherein the dispenser can be reloaded with the plurality of waste bags from the interior of the main body.

8. The system of claim 1, further comprising:
wherein the strap is configured of hook and loop;
wherein the strap is secured to the main body.

9. The system of claim 1, further comprising:
wherein the strap is configured of a bungee cord;
wherein the strap is secured to the main body.

10. A device for containment of pet waste, comprising:
a main body;
the main body extending a length from a first end to a second end between opposing sides;
the main body having an exterior surface and a hollow interior;
the main body having an upper portion;
the upper portion of the main body having a top interior;
the upper portion of the main body having a top seam;
the main body having a lower portion;
the lower portion of the main body having a bottom interior;
the lower portion of the main body having a bottom seam;
the main body having a liner;
a closure feature;
a dispenser;
the dispenser extending a length from a first end to a second end between opposing sides;
the dispenser having an exterior surface and a hollow interior;
the dispenser having an opening;
a strap;
the strap extending a length from a first end to a second end between opposing sides;
the strap having a tightener;
the tightener of the strap having a first aperture;
the tightener of the strap having a second aperture.

11. The system of claim 10, further comprising:
wherein the strap is configured to secure to a dog harness by pulling the strap tight through the first aperture and the second aperture.

12. A method of containing pet waste, comprising the steps:
providing a device for containing pet waste; the device for containing pet waste comprising:
a main body;
the main body extending a length from a first end to a second end between opposing sides;
the main body having an exterior surface and a hollow interior;
the main body having an upper portion;
the upper portion of the main body having a top interior;
the upper portion of the main body having a top seam;
the main body having a lower portion;
the lower portion of the main body having a bottom interior;
the lower portion of the main body having a bottom seam;
the main body having a liner;
a closure feature;
a dispenser;
the dispenser extending a length from a first end to a second end between opposing sides;
the dispenser having an exterior surface and a hollow interior;
the dispenser having an opening;
a strap;
the strap extending a length from a first end to a second end between opposing sides;
securing the device for containing pet waste;
picking up pet waste;
placing the pet waste into the hollow interior of the device for containing pet waste;
closing the device for containing pet waste.

13. The method of claim 12, further comprising:
wherein the device for containing pet waste is secured to the harness of a pet.

14. The method of claim 12, further comprising:
wherein a doggy bag is used to pick up the pet waste.

15. The method of claim 12, further comprising the steps:
removing the pet waste device;
disposing of the contents of the pet waste device;
cleaning the interior surface of the pet waste device.
